(19) United States
(12) Patent Application Publication
(10) Pub. No.: US 2014/0158283 A1
(43) Pub. Date: Jun. 12, 2014

(54) Method of Forming a Repair Patch for Repairing Inflatable Objects

(71) Applicant: BASIC ELECTRONICS, INC., Garden Grove, CA (US)

(72) Inventor: Alfiero F. Balzano, Garden Grove, CA (US)

(73) Assignee: BASIC ELECTRONICS, INC., Garden Grove, CA (US)

(21) Appl. No.: 13/712,851

(22) Filed: Dec. 12, 2012

(51) Int. Cl. B32B 37/12; B29C 73/10

(52) U.S. Cl. CPC B32B 37/1284; B29C 73/10
USPC 156/94; 427/207.1; 156/60

(57) ABSTRACT

A method of forming a repair patch for repairing a damaged inflatable object is provided. The method comprises forming a backing formed polyimide material and applying as adhesive material to the backing, for securing the polyimide backing material to the inflatable object. The backing may be formed as a thin film of polyimide material and the adhesive may be formed as thin film of adhesive having a high temperature resistance, e.g. 300° F. or higher. The adhesive may be formed of silicon or acrylic contact adhesive having high temperature resistance. The release layer may be applied to the adhesive material.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a method of forming a repair patch for repairing damaged inflatable objects, such as tires, inner tubes, hoses, or inflatable watercraft.

It is well known to use patches to repair leaks for inflatable objects, such as tires or inner tubes. Such repair patches are commonly formed of rubber or some polymeric material which may be glued to the leaking surface, at a suitable location. While conventional patches are typically adequate to seal the leaky surface, the durability of such conventional patches are frequently limited, and unsuited for a demanding environments and/or conditions of use.

For example, competitive bicycling events may be staged for long distances, e.g. a hundred (100) miles or more, across hot desert roads. To reliably seal a leaky and/or punctured tire or inner tube under those conditions, a repair patch must have high strength, be heat resistant, remain flexible at high temperatures, and have a thermal expansion coefficient that approximates the thermal expansion rate of the material which the repair patch is applied. Further, the patch is preferably resistant to becoming brittle when exposed to UV light or dry atmospheres for long extended periods of time.

Patches used for other type of tires, e.g. motorcycle tires, car tires, truck tires, etc., have similar requirements, dictated by their specific operating environments and/or conditions. For example, when used on mountain bike tires, the strength and puncture resistance of the repair patch may be key requirements for high performance and reliability.

Conventional patches for tires and other inflatable objects may be made from material, such as polyamides. While such materials are generally useful to repair leaky surfaces, they may have a maximum working temperature that is considerably lower than the temperature than desert sands can reach. As such, the polyamide patches may fail in such an extreme environments. Moreover, the expansion rate of such polyamides, which may be in the range of 110 (μm/m)/° C., is considerably greater than the thermal expansion rate of rubber, which may only be 77 (μm/m)/° C. Because of the difference in thermal expansion rates, polyamide patches may be unsuitable for use to patch products experiencing substantial temperature changes. Moreover, polyamides may become brittle when exposed to UV light or dry atmospheres, those properties indicate that polyamide patches may be unsuitable for high performance patching needs, for patches relied upon for extended periods of use, or for use in more challenging environments.

When the repair patch is used to repair a leak in an inflatable watercraft, the dangers associated with the patch becoming brittle or otherwise failing to maintain a seal on an inflatable air chamber area are a key concern, as is the ability to stand up to high temperatures and the effect of salt water.

Even where the patch is used to seal leaks in common inflatable objects found in the household, e.g. hoses, pool toys and the like, it remains desirable that the patch remain effective for the life of inflatable product, to minimize the cost of replacement, repair time and inconvenience.

It is therefore desirable to provide a method of forma a repair patch for repairing an inflatable object using an improved patch which is suitable for use in challenging environments, provides high strength, heat resistance, chemical resistance, thermal stability, flexibility, and reliability that exceeds that available from conventional patches.

### BRIEF SUMMARY

A method is provided for forming a repair patch for repairing a damaged inflatable objects. The method comprises forming a patch backing formed of polyimide material, or a derivative thereof, and applying an adhesive material to the backing to secure the polyimide material to the inflatable object.

In one embodiment the backing is UV stable and structurally stable at temperatures up to approximately 300° F., has a working temperature of approximately 500° F.

In one embodiment the backing is formed to have a tensile strength of between 24,000-33,000 lbs/in² and a shear strength of approximately 13,800 N/cm^{2.}

In one embodiment the backing is formed to have thickness of approximately 0.002-0.003 inches, and may define beveled or rounded edges to mitigate ripping or tearing of the adjacent surfaces, e.g. inner tube, or tire.

The adhesive material may be formed of as a thin film of silicon or acrylic contact adhesive, e.g. between 0.002-0.003 inches thick, forming a cohesive bond between the polyimide repair patch and the tire area requiring repair. A release layer may be formed on the adhesive material.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front perspective of a repair patch used in accordance with the present invention; and

FIG. 2 is a cross sectional view of the repair patch shown at FIG. 1.

### DETAILED DESCRIPTION

The present method of forming a repair patch and corresponding method of repairing inflatable objects makes use of polyimide material as backing material for a repair patch. Polyimides are class of thermally stable polymers. From a structural viewpoint, polyimide is a polymer that contains an imide group. Polyimides are incredibly strong and are characterized by outstanding heat and chemical resistant polymers. These properties come from strong intermolecular forces between the polymer chains. Polyimides are also resistant to oils, greases, and fats, and can withstand microwave radiation.

Techniques for fabricating polyimides are well known. The most widely practiced procedure for polyimide synthesis is a two-step poly(amic acid) process, which involves reacting a dianhydride and diamine under ambient conditions in a dipolar aprotic solvent, such as N,N-dimethylacetamide (DMAc) or N-methylprrolidinone (NMP) to yield the corresponding poly(amic acid), which is then cyclized into the final polyimide. This process involving a soluble polymer precursor was pioneered by workers at DuPont™ in the 1950's, and to this day, continues to be the primary route by which most polyimides are made.

Most polyimides are infusible and insoluble due to their planar aromatic and hetero-aromatic structures, and thus usually need to be processed from solvents. The DuPont™ method provided the first such solvent-based route to process these polyimides. The process also enabled the first polyimide of significant commercial importance, ‘Kapton™’, to enter the market. Commercially available polyimides, such as Ultem™ from General Electric®, and Kapton™ from DuPont™, have outstanding mechanical and thermal properties, allowing them to be used in place of metals and glass in many high performance applications in the electronic, automotive, and aerospace industries.

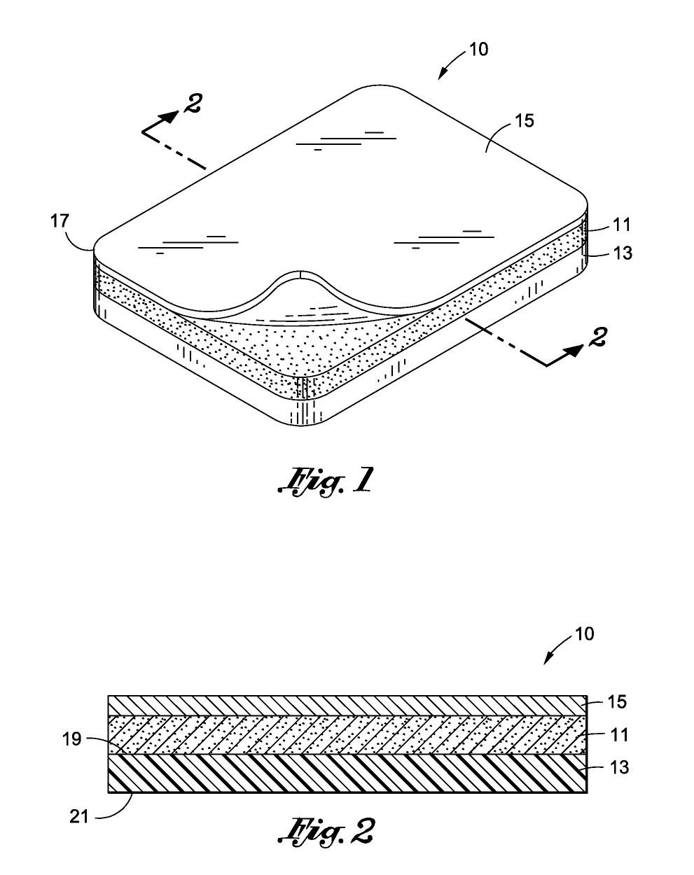

In accordance with the present invention, the repair patch is applied to an inflatable object having a puncture or other leak therein. An exemplary construction of the repair is shown at FIGS. 1 and 2. As shown therein, the repair patch 10 is formed to have a base layer, or backing 13, an adhesive layer 11 and a release layer 15. The backing 13 includes a first surface 19 in contact with adhesive layer 11, and a second surface 21, which forms an upper surface of the repair patch 10 after it is applied to the inflatable objects.

In implementing the repair the surface of the inflatable object may be first prepared, e.g. by scrubbing or sanding the area proximate the puncture to facilitate adhesion of the repair patch. Once the surface is prepared, the repair patch may be applied by removing the peel off adhesive layer 15 and pressing the adhesive layer 11 against the surface of the inflatable object, e.g. a bicycle tire. Pressure may be applied to backing 13 to facilitate bonding of adhesive layer 11 to the surface of the inflatable object.

As shown in the embodiment at FIG. 1, the corners 17 of the repair patch 10 may be rounded or beveled to mitigate ripping or tearing of the adjacent surfaces of the inflatable objects.

A cross sectional view of exemplary repair patch 10 is shown at FIG. 2, and includes the backing 13, the adhesive 11, and the release layer 15.

In the presently preferred embodiment, the backing material used to form the repair patch includes a polyamide marketed by 3M Corporation. The repair patch further includes an adhesive layer formed along a surface of the polyimide backing material, with a peel off release layer applied along the exposed surface of the adhesive. The adhesive layer may be implemented as a thin film of formable acrylic or silicone contact adhesive having high temperature resistance.

In the present preferred embodiment the polyamide patch is formed to approximately 1 to 2 inches long and approximately 1 inch wide. The particular size and thickness of the polyimide adhesive and backing layer may vary in accordance with the particular application. However, in an embodiment suitable for use in patching bicycle tires and inner tubes, the polyamide backing has a thickness of approximately 0.003 inches or less, and the adhesive layer has a thickness of approximately 0.002 inches or less.

In the presently preferred embodiment the polyimide backing has a high temperature resistance, e.g. 300° F. or higher, a shear strength of about 13,800 N/cm², and is UV stable. Further, the edges of the polyamide patch may be rounded or beveled to mitigate ripping or tearing of the adjacent surfaces of the inflatable object or other adjacent surfaces.

The above description is given by way of example, and not limitation. Given the above disclosure, one skilled in the art could devise variations that are within the scope and spirit of the invention disclosed herein, including the selection of different polyimides or adhesives, and the inclusion of additional materials to better accommodate a particular application. Further, the various features of the embodiments disclosed herein can be used alone, or in varying combinations with each other and are not intended to be limited to the specific combination described herein. Thus, the scope of the claims is not to be limited by the disclosed embodiments.

1. A method of forming a repair patch for repairing a damaged rubber tire comprising:
forming a backing of polyimide material, the backing defining opposing first and second backing surfaces;
applying a contact adhesive to the backing first surface;
the when inflated up to approximately 120 psi and at a temperature of Up to approximately 300° F.

2. The method as recited in claim 1 wherein the backing is formed of a thin layer of polyimide material and the adhesive is formed as a thin, film adhesive having a high temperature resistance.

3. The method as recited in claim 2 wherein the adhesive is formed, of a silicon contact adhesive.

4. The method as recited in claim 2 wherein the adhesive is formed of an acrylic contact adhesive.

5. The method as recited in claim 1 wherein the backing is formed to have a thickness of approximately 0.002-0.003 inches.

6. The method as recited in claim 2 wherein the adhesive material is between 0.002-0.003 inches thick.

7. The method as recited in claim 2 wherein the backing is structurally stable at temperatures up to approximately 300° F.

8. The method as recited in claim 7 wherein the backing is formed to have a working temperature of approximately 500° F.

9. The method as recited in claim 1 wherein the backing is formed to have a tensile strength of between 24,000-33,000 lbs/in².

10. The method as recited in claim 1 wherein the backing is formed to have a sheer strength of approximately 13,800 N/cm².

11. The method as recited in claim 1 further comprising applying a release layer to the adhesive material.

12. The method as recited in claim 1 wherein the backing is formed of UV stable material.

13. The method as recited in claim 1 wherein the backing is formed to define rounded edges.

14. A method of repairing a damaged inflatable rubber object comprising:
applying a repair patch to the inflatable object, the repair patch having a backing formed of polyimide material, the backing defining opposing first and second surfaces, an adhesive material formed on the backing first surface for securing the polyimide material to the inflatable object, the polyimide material being effective to maintain a seal when the object is inflated up to approximately 120 psi and at a temperature of up in approximately 300° F.
